(19) United States
(12) Patent Application Publication
(10) Pub. No.: US 2012/0145265 A1
(43) Pub. Date: Jun. 14, 2012

(54) System for Conditioning Fluids Using Fermi Energy

(76) Inventor: MARK STEPHENSON, Parksville (CA)

(21) Appl. No.: 12/963,984

(22) Filed: Dec. 9, 2010

(51) Int. Cl. F15D 1/00

(52) U.S. Cl. 137/803

(57) ABSTRACT

The system conditions a variety of fluids thereby improving the performance of the fluid. The system includes a containment structure for containing a first member comprising a first material having a first Fermi level and a second member comprising a second material comprising a second Fermi level. The first Fermi level is higher than the second Fermi level. The members are adjacent and separated by a separation distance sufficient to permit the fluid to be directed through the containment structure and between the first member and the second member.

### CROSS-REFERENCE TO RELATED APPLICATIONS

N/A

### FEDERAL FUNDING

N/A

### FIELD OF THE INVENTION

This invention relates to the field of conditioning working fluids such as gases and liquids and specifically to a method and apparatus for conditioning fluids such as combustion air, water, fuel and oil by passing the fluid through Fermi energy field generated by adjacent dissimilar metals.

### BACKGROUND OF THE INVENTION

The performance of fluids can often be enhanced by electro-chemical treatment. For example the taste of water is often degraded by the presence of ions which impart a foul taste. This discourages people from drinking the correct amount of water. There are many prior art, examples of additives, filters and conditioning systems to treat potable water to remove impurities to give water a more pleasant taste. However, these examples are often not effective as they can be expensive and can, in the case of chemical additives, be harmful. Such systems require the use of electrical power and can be repair intensive.

in another example, combustion air for internal combustion engines and other combustion systems can be electro-chemically treated to improve burn characteristics, fuel efficiency and reduce pollution. However, prior art treatment systems often rely upon expensive metals.

In yet another example, fuels can be electro-chemically altered to enhance their combustion properties to make them burn cleaner.

In yet another example, lubricating oils used in internal combustion engines are contaminated by water and particulates from the combustion process. Such contaminants are not filtered properly using prior art oil filters and create pollution, lubricant contamination and engine wear.

Therefore there is a need for system for conditioning a working fluid, whether it be gaseous or liquid, to improve its operating characteristics without having to rely exclusively on chemical additives or prior art filters, that is simple and inexpensive to operate, environmentally benign and requires little maintenance.

### SUMMARY OF THE INVENTION

To overcome the aforementioned deficiencies the present invention is system for conditioning a fluid comprising a containment structure for containing an at least one first member comprising a first material having a first Fermi level and an at least one second member comprising a second material comprising a second Fermi level. The first Fermi level is higher than said second Fermi level. The at least one first member and the at least one second member are adjacent and parallel and separated by a separation distance sufficient to permit the fluid to be directed through the containment structure and between the at least one first member and the at least one second member. The first Fermi level and the second Fermi level interact to create a fluid conditioning electron field through which the fluid passes and is conditioned for improved performance.

In one example of the invention the containment structure is a vessel having an input orifice for connection to a pressurized supply of the fluid and an output orifice for connection to a fluid consumer. The fluid can be a gas or a liquid and can comprise combustion air, a fuel, an oil lubricant to a flow of gaseous combustion products. The fluid consumer can be a person who may wish to drink conditioned potable water, an internal combustion engine, a gas cooking apparatus or a wood fired heating apparatus.

In another example of the invention, the at least one first member is a first thin rectangular member or strip having a first width, a first length and a first thickness. The at least one second member is a parallel second thin rectangular member having a second width, a second length and a second thickness so that a first member reactive area having the first Fermi level and a second member reactive area having the second Fermi level are formed,

In yet another example of the invention the separation distance is created by an at least one spacer disposed between the at least one first member and the at least one second member.

In one example of the invention the at least one first member comprises a plurality of first members and the at least one second member comprises a plurality of second members. These members are arranged in an alternating adjacent and parallel relationship separated by the separation distance thereby forming a rectangular conditioning deck.

In another example of the invention the rectangular conditioning deck may be rolled to form a cylindrical conditioning roll suitable for a cylindrical containment structure.

In still another example of the invention the at least one first member may comprise four first members joined along their respective lengths to form a first rectangular conduit having a first conduit width and a first conduit. The at least one second member may comprise four second members joined along their respective lengths to form a second rectangular conduit having a second conduit length less equal to said first conduit length and having a second conduit width less than said first conduit width. The second conduit can be nested within the first conduit and separated by the separation distance thereby forming a rectangular conditioning conduit suitable for a rectangular containment structure. An additional first rectangular conduit can be nested within the second rectangular conduit and an additional second rectangular conduit can be nested within said additional first rectangular conduit thereby forming a conditioning conduit having four nested conditioning rectangles.

The first material is titanium and the second material can be silver or aluminum depending on the application. The thickness of the members is between 0.005 inches and 0.010 inches.

Although the conditioning deck is generally used in a fluid flow environment it can be placed within a dish or bowl of water or some other containment structure

### OBJECTS ADVANTAGES OF THE PRESENT INVENTION

One object of the present invention is to reduce pollution caused by internal combustion engines.

Another object is to reduce fuel consumption.

A further object is to improve the taste of potable water.

A still further object is to remove volatiles impurities from crankcase ventilation systems.

One object of the invention is to prolong the life of lubricants,

One advantage of the invention is that it can be easily retrofitted to a domestic water system or automobile fuel system.

Another advantage of the system is that the material components do not enter the fluid stream and do not decompose.

A further advantage of the invention is that it is inexpensive to manufacture and easy to install. Yet another advantage of the invention is that it does not use chemicals, external power sources and has no moving parts.

Other technical advantages may be readily apparent to one skilled in the art after review of the following figures, description and claims associated herewith.

### BRIEF DESCRIPTION OF THE DRAWINGS

FIG. 1 is a view of one embodiment of the invention,

FIG. 2 is a view of a second embodiment of the invention.

FIG. 3 is a view of a third embodiment of the invention.

FIG. 4 is a view of a fourth embodiment of the invention,

FIG. 5 is a view of a fifth embodiment of the invention.

FIG. 6 is a view of a sixth embodiment of the invention.

FIG. 7 is a view of another embodiment of the invention.

FIG. 8 is a view of a circular embodiment of the invention.

FIG. 9 is a view of a square tubular embodiment of the invention.

### DESCRIPTION OF THE INVENTION

Water Conditioning Embodiment

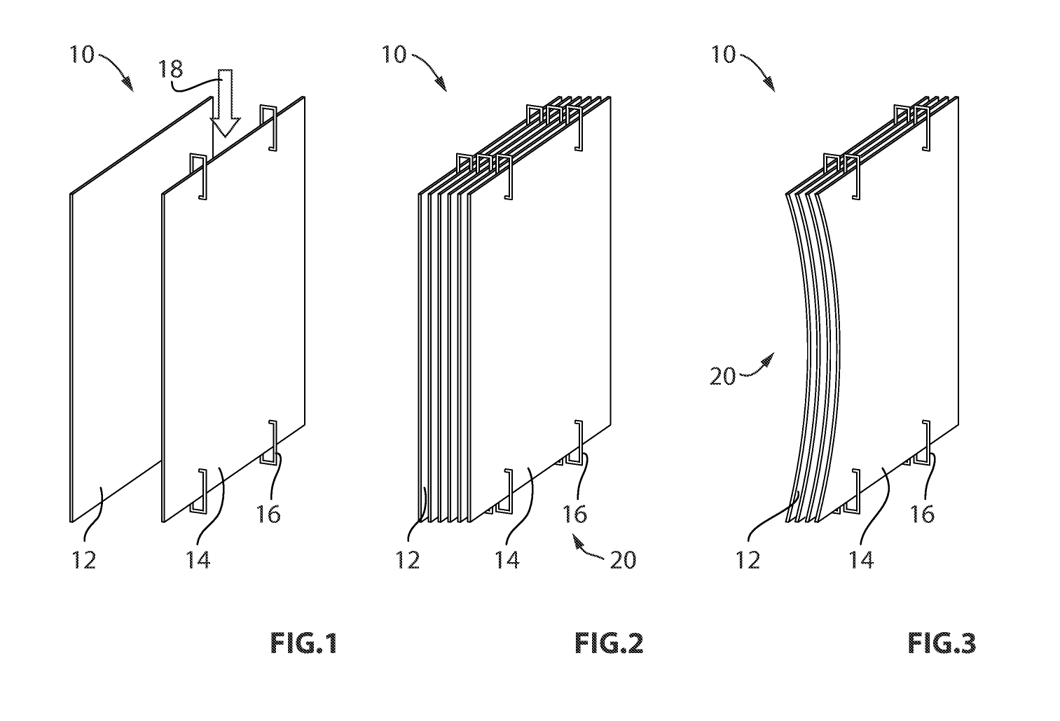

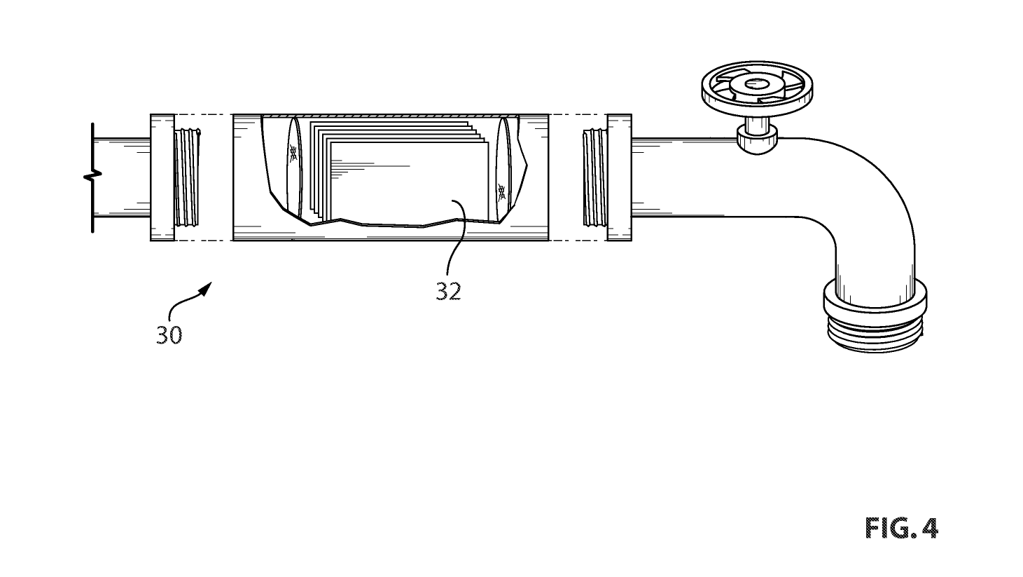

Referring to FIG. 1 to FIG. 6 the apparatus 10 comprises a pair of parallel and closely spaced metallic plates 12 and 14. In one embodiment of the invention, as it pertains to the conditioning of water, one plate 12 is silver and the plate 14 is titanium. Inert spacers 16 are formed within the titanium plate to provide a sufficient distance between the plates to permit fluid flow 18 between them. As shown in FIG. 2 and FIG. 3, the plates may be configured to form stacks 20 and then modified by curving or rolling to suit any application. Consistent spacing between the alternating metal layers is produced by tabs formed from cut and bent sections of the titanium plates. Ideally, the top and bottom edges of the titanium plates are used to form the tab section which parallels the length of the plates. These tabs need only to be a few millimetres in width and length and angled sufficiently to protrude from the plate's surface allowing the adjacent plate to contact only the tab's edge. This allows the plate surfaces to parallel one another without contact other than that of the angled protruding tab. If complete electrical isolation between the plates is desired it is possible to use non conductive tabs of suitable compatible materials that can be fit with minimal interference or restriction to fluid flow, or, a suitably compatible coating can be applied to the contact area of the protruding tab.

Each plate has its own unique Fermi, surface and hence has its own quantum mechanical properties. When the two plates are placed sufficiently proximate to each other a Fermi energy field is established between them. The energy field is electrostatic in nature and is caused by the electron flow over the Fermi surface of each material. Therefore, the electrostatic field can be created without the use of any extraneous electronic or magnetic field generating equipment. The electrostatic field between the two strips alters the electron state of the water molecules thereby conditioning them.

For water conditioning, titanium and silver metals are ideal. The titanium and silver metals are ideally used in thin strips disposed adjacent to each other as shown in FIG. 2 so that their respective Fermi surfaces form an electrostatic field. The titanium is commercially available. The silver metal is preferably of 99% or greater purity and is also commercially available. These metal strips are cut to dimensions suitable for the desired application. The length of each strip of metal is generally greater than the width. The thin strips of metals are arranged in alternating order with their broad surface areas facing each other as shown in FIGS. 2 and 3. The metals are slightly separated from one another. FIGS. 4, 5 and 6 illustrate other applications as they pertain to water conditioning. FIG. 4 illustrates an application within the stream of a domestic water system 30. A system for a 600 ml water bottle application can have approximately 14 plates 32 in total with each having a surface area of 12 min×25 mm equaling 300 mm² per side. Since both sides are capable of reacting with the adjacent plate's surface each plate provides 600 mm² of surface area. The combined assembly of layered plates takes up very little area and provides minimal resistance to the passing fluid.

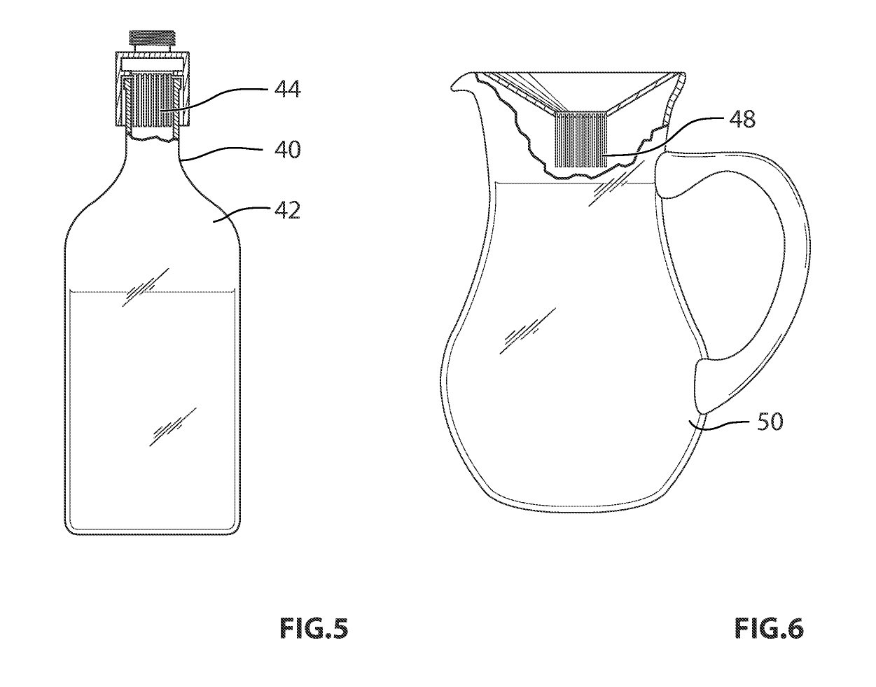

FIG. 5 illustrates an application within the neck 40 of a water bottle 42 wherein water is poured over the stack 44. In FIG. 6, the stack is submerged in a water jug. On larger applications such as that of a main water line of a house, as illustrated in FIG. 4, the plates could be cut, for example 28 min×30 mm providing 1680 mm² of working surface area per plate. In this example approximately 20 plates would provide significant working surface area while producing little resistance to fluid passage. The dimensions and number of plates can have considerable variations, such as only a few long narrow strips of titanium and silver metals to fit a relatively small tubing size or a multitude of short, wide strips 48 in an application acceptable to a large housing such as a water pitcher 50 insert as illustrated in FIG. 6.

In one embodiment, the plates are of equal dimensions and approximately 0.005-0.010 inches thick. The titanium plates are cut and formed with the protruding spacer tabs and the silver plates are without the cut tabs, because silver is much softer and would not hold its position securely. This greatly facilitates manufacturing as only the titanium material needs to be cut and formed. As well, during assembly the alternating layers of materials can easily be arranged and positioned with minimal complications. Assembling the plates in alternating order produces, as a result of the cut and formed spacer tabs, parallel spaced surfaces of titanium and silver. The spaces between the plates are preferred to be minimal without, however, significantly affecting fluid flow. The combined assembly of alternating titanium and silver plates is designed for the application to not affect the total volume flow of the water,

This system is not designed to act as a filter; its purpose is to modify water for improved taste and other characteristics. The materials comprising this system do not decompose or become corroded in their intended environment. This system requires no maintenance and requires no other support to aid in its function such as heat, electricity, pressure or additives of any sort.

Field testing the water conditioning potential of the specific metal assembly described above indicates that algae growth in standing water was significantly reduced. For example, the water dish used for a family's dog would normally become contaminated with algae within two days in the hot summer sun. However, when the water was passed through the specific assembly of metals described above, it remained clear for several weeks. Standing water in vases containing cut flowers normally becomes contaminated and begins to produce an offensive odour within one week. When fresh water is passed through the assembly of metals, the algae growth was reduced and the water would not produce offensive odours even after 2 weeks. Swimming pool water once conditioned indicated similar results. Lab testing regular tap water before and after conditioning using the described technology indicated that no metals were being emitted into the water from the device.

Combustion Air Conditioning Embodiment

By experimentation, this technology has been effectively applied to the air induction side of combustion systems, including vehicle internal combustion engines. Testing involved the replacement of the relatively expensive silver material with inexpensive aluminum sheet material. The titanium remains as described. The combination of aluminum and titanium has demonstrated to effectively modify the air without pre-heating as it is being inducted into the combustion apparatus. The combustion characteristics, as a result of the modified air, are enhanced considerably with any fuel type, regardless of quality. Since air is the common oxidant used with all fuels and combustion systems this modification technology can safely improve the combustion characteristics of virtually any fuel, including gaseous, liquid and even solid fuels, such as coal.

Upon field testing a small air intake conditioning unit positioned in a wood burning fireplace it was observed that the wood burns more completely, easily allowing larger pieces to be consumed ultimately requiring less splitting. The heat release also appears to radiate more effectively into the atmosphere as a result of the smoother combustion process. Pellet stoves, which burn compressed wood pellets, also have been proven to burn hotter, cleaner and more efficiently when the combustion air is modified according. Wood stove applications involving the adaption of the technology to a small port to allow a fraction of combustion air to be drawn through the assembly. Results indicate an approximate 20% hotter combustion process, as measured by the stove's outer surface temperature. Also, lower soot levels in the exhaust stack were confirmed by inspection after several months of operation. Fireplace applications involving the use of the technology to condition a small portion of the fire's combustion air indicated noteworthy improvements to heat output and extended burn characteristics of the wood. Pellet stoves applications involving the modification of pre-combustion air indicated an increase in heat output by approximately 15%.

This technology can effectively modify the air for the combustion process of virtually any fuel and can be inexpensively and safely adapted to any combustion system. The market categories chosen can be divided into general categories such as emissions reduction, performance enhancement, safety and efficiency improvement. The automotive industry, for example, would provide a number of opportunities for each specific category of functional improvement such as performance aftermarket, for diesel or gasoline engines, original equipment for emissions reduction or retrofit aftermarket for emissions or efficiency applications. As well, the technology imparts absolutely no negative effect on sensors, computer systems or engine components allowing freedom from warranty claims or emissions components concerns. There are no maintenance procedures and the intake tubing insert assembly would be easy to install and would require very little effort to manufacture or to adapt to any desired application.

Intake Air Modification on Internal Combustion Engines

Modifying the air before it enters the combustion chamber of an engine produces a significant improvement to the combustion process, regardless of fuel type or quality. The modified air is not affected by heat as observed in field applications on industrial diesel engines where equally satisfactory results were achieved whether the air conditioning assembly was installed before the turbo charger, when the air is at ambient temperature, or after the turbo charger when the air temperature can reach over 200 degrees F.

The modified air's combustion enhancing characteristics are not affected by the distance the conditioned air must travel throughout the engine's induction system before entering the combustion chamber. Field testing indicates equally positive performance improvements whether the air is modified before the turbo charger where it must pass through the intercooler, and all of its ducting (several feet of travel), or if the assembly of materials are placed immediately in front of the engine's intake port to allow the conditioned air to pass directly into the combustion chamber.

The modified air is not affected by contact with metal ducting such as typically used in inter cooler connections or intercoolers. Field testing indicates that a diesel engine, of virtually any size, year or model type, will produce more power, run smoother and have lower exhaust emissions when the combustion air is modified using the described technology. For example, a 1996 Kenworth gravel truck with a 6 cylinder, turbocharged, intercooled Cat engine consistently obtained an improved, measured fuel efficiency of 12%. Also, the local district's mower tractor with a 4 cylinder turbo charged, diesel engine routinely obtained a measured fuel efficiency of 20% throughout the summer. As well, a local wood chipping facility allowed the air modifying technology to be installed on a large wood grinding machine utilizing a 12 cylinder, duel turbo charged Cat engine which consistently obtained a measured fuel efficiency of 18%. This engine's exhaust smoke emissions were estimated to have been reduced 50%.

Oil Vapour Modification

Using the described technology to modify oil vapour emissions as produced as blow-by gases on a 2007 CiMC truck with a 5 cylinder gasoline engine produced very desirable results. The oil maintained its viscosity and cleanliness of carbon and water for well over 20 000 Kilometres and 22 months of operation. Oil samples were taken to confirm viscosity stabilization and water

Fuel Modification

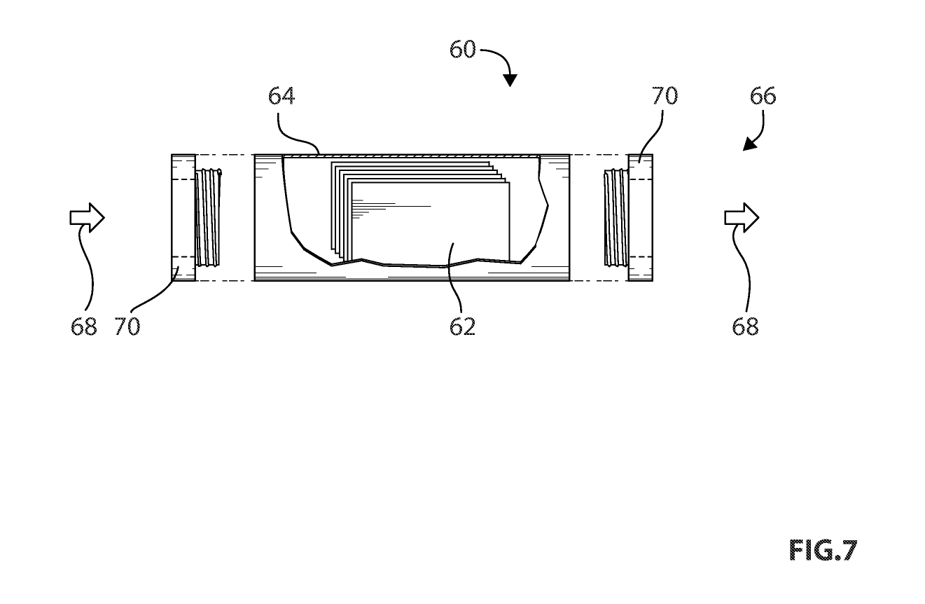

FIG. 7 illustrates one possible embodiment 60 of the invention for use in modifying fuel. A stack of strips 62 is contained within a circular vessel 64 in a fuel line 66. Fuel passes through the stack as shown by the arrows 68. The end caps 70 of the vessel would be connected to the fuel line.

For example, A 2004 Deutz, 4 cylinder diesel engine in an industrial gravel screening machine indicated an approximate 3% reduction in fuel consumption when the fuel was directed through the assembly of materials prior to combustion.

When these fuels pass through a self generating energy field produced between the opposing surfaces of titanium and aluminum, the electron distortion imparted on the molecules enhances their decomposition characteristics. As a result, less energy is required to initiate and propagate combustion and their accelerated electronic state provides smoother more sustainable chemical reactions.

This technology involves the use of specific metals in an arrangement that produces an energy field capable of stimulating the electrons of the fuel molecules as they pass through it. Since the electrons ultimately define the atom's position on the molecule, specific manipulation will assist the ease of which the atoms can be separated. It is understood that molecules must decompose to atoms for combustion to proceed, therefore proper electron distortion provides subsequently less bond energy to overcome during the decomposition process. The chain reaction involving a controlled combustion process requires energy to influence atom separation, this is often the reason that ignition is not always an easy process. There simply isn't enough heat energy to effect molecular decomposition. However, after the fuel has passed through the arrangement of specific metals their distorted electron configurations require less external energy to initiate decomposition and subsequent combustion. Extensive research and development has indicated that specifically titanium and aluminum metals in an opposing parallel plate type arrangement with slight spacing between them produces the specific energy fields necessary to successfully distort and modify the electron configuration of the passing hydrocarbon fuels. These two metals are ideally in a form such as thin plates that would allow them to be arranged in an alternating order with their broad, flat surfaces facing each other. In order to maintain slight spacing between the opposing surfaces small tabs are cut and formed along the edges of every other layers of positioned metal. For example, the top and bottom edges of the titanium layer can be cut and formed with small tabs to provide separation when layered with the aluminum plate, which is simply flat.

The formed tabs provide a means of controlling the spaces between the layers and can be of any configuration desirable to produce a controlled parallel, or even nonparallel, arrangement of alternating layers of these two metals. Since it is believed that the spacing between the dissimilar materials provides the medium for which the hydrocarbon fuels pass through, it is important they exist. Many alternative methods are available to provide spacing such as corrugations, dimples or even suitable inserts. Regardless of how they are formed, the spaces not only provide the necessary reaction zone, but also provide a means of allowing the fuels to enter and exit the assembly with minimal restriction. By providing relatively uninterrupted flow potential, this assembly can be inserted into any desirable sized tubing system for the chosen application.

For example, an assembly of the arranged metals for an application suitable for adapting to a propane barbecue would be approximately 25 mm in length and the individual layers of alternating metals would be approximately 12 mm in width. It would require only a few pieces of each metal to provide sufficient surface area and subsequent reactivity for such an application. The assembly of layered metals could be inserted into a suitable housing such as a 19 mm diameter cylinder 35 mm in length with proper fittings to seal the assembly and adapt it into the propane line. In this example, the fluid would simply flow through the assembly before it reaches the burner nozzle.

Another example for a larger application, such as a natural gas burner for an average sized would be approximately 100 mm in length with the individual metal layers approximately 15 mm in width and 0.3 mm in thickness. It would require only approximately 10 individual pieces of alternating metals to fit into a 25 mm tubing with appropriate threads for securing the assembly into the natural gas line. This example would not restrict the fuel flow and it would easily provide the necessary reactivity for the desired functional improvements. The assembly of these dimensions would also work well on a large diesel engine application. The sealed housing assembly would simply be installed in the diesel fuel line anywhere convenient before the injection pump.

The dimensions and number of alternating dissimilar metal plates can have considerable variations in size and number of plates, even two opposing plates of these two different metals can produce noteworthy reactions.

This alternating dissimilar metal layer system is adaptable to fit virtually any sized fuel system. The assembly can be inserted directly into the fuel line or sealed in its own housing with appropriate threads, fittings or openings to allow implementation into the desired application without adversely affecting fuel flow. The spaces between the layered plates provide, not only the reaction medium for the passing fluid, but are able to direct the fuels through the assembly.

Cleaning Lubricating Oil

The lubricating oil of most internal combustion engines becomes contaminated with carbon and water most often as a result of combustion gases escaping past the rings and penetrating the liquid oil. Before these contaminates enter the oil however, it has been discovered that these gases have unbalanced electron charges which allows them to be drawn to specific electromagnetic energy fields.

This invention relates to a system utilizing specific metals in a configuration and arrangement to produce an energy field capable of attracting volatile combustion contaminants from the crankcase cavity of an internal combustion engine before they enter the oil. When this system is installed in a crankcase emissions evacuation tube the contaminants, once drawn into and through the apparatus, can simply be processed with the regular blow-by emissions.

Many devices exist in the market that are designed to filter or clean the engine oil. Most systems use some type of filter medium to trap or separate the oil's contaminants. Most filter systems require periodic maintenance or replacement because they become excessively contaminated. Other systems use centrifugal force to separate heavier, unwanted particles. It has been realized however, that since most of the oil contaminants come from the combustion chamber, there exists an opportunity to extract them before they penetrate the liquid oil.

This system offers several advantages that have not been experienced by existing, available oil cleaning systems. These advantages are possible as a result of utilizing the differences in electrical conductivity between the oil and the contaminants that have escaped past the rings from the combustion chamber. It has also been discovered that two specific metals in the configuration described produce an energy field that allows the charged carbon particles and strong polar water molecules to be drawn to it. Since the assembly does not contain any type of filter medium, the attracted unwanted contaminants simply pass through as a result of the crankcase evacuation system and mix with the escaping crankcase emissions. Since this system relies on the electron interaction between two specific dissimilar solid opposing surfaces, there is no filter medium to entrap particles. Subsequently, there are no filters to replace or become contaminated. Also, there are no electrical connections or other support systems necessary to aid in its function. This system does not, in any way, negatively affect the engine's oil filtration system and in fact will aid in the filter's function by removing water and sludge forming carbon, white still volatile, before it reaches the oil.

Extensive research and development has indicated that specifically titanium and aluminum metals in an opposing parallel plate type configuration with slight spacing between them produces the specific energy fields capable of drawing the volatile contaminants from the engine's crankcase cavity before they are absorbed into the liquid oil. These two metals are ideally in a form such as thin plates that would allow them to be arranged in an alternating order with their broad, flat surfaces facing each other. In order to maintain slight spacing between the opposing surfaces small tabs are cut and formed along the edges of every other layer of positioned metal. For example, the top and bottom edges of the titanium layers can be cut and formed with small tabs to allow separation when layered with the aluminum plate, which is simply flat. The formed tabs provide a means of controlling the spaces between the layers and can be of any configuration desirable to provide a controlled parallel, or even non parallel, arrangement of alternating layers of these two metals.

The spacing between the dissimilar materials provides the medium for which the combustion contaminants are attracted to, it is important they exist. Many alternative methods are available to provide spacing such as corrugations, dimples, or even suitable inserts. Regardless of how they are formed, the spaces not only provide the necessary reaction zone but also provide a means of allowing the contaminants to enter and exit the assembly with minimal restriction. By providing relatively uninterrupted flow characteristics, this assembly can be inserted into any desirable sized tubing system for the chosen application. For example, a small lawn mower engine may require an assembly of alternating dissimilar metal plates to fit into an 8 mm diameter tubing and be only approximately 10 mm in length. Such a system would require only a few layers of alternating metals. A larger engine such as a diesel truck engine may require an assembly of 50 mm in length to fit inside a 25 mm diameter tubing. An assembly of this size would require approximately 8 layers of alternating dissimilar metals spaced appropriately. In order to insert the various sized assemblies of layered metals into their respective positions, usually in the crankcase ventilation tubing, the assembly of metal layers are encompassed with a thin layer of permeable metal or screen. This method allows the secured assembly to be inserted into the appropriate sized tubing, for the application, without the requirement of any other supporting system such as a housing assembly or elaborate tubing system. This assembly, as an insert, would be scaled for the chosen application and simply positioned inside the tubing. If it is desired to hold the assembly, insert, in a specific position inside the tubing a simple clamp often works welt.

Since the combustion contaminants that would eventually manage to enter the oil must first pass through the crankcase cavity, it is convenient and practical to insert the assembly into the engine's crankcase emissions tubing. The unit assembly is able to attract the volatile contaminants before they penetrate the oil and its design does not impede the flow of the blow-by emissions. This system works on all engines even on applications with an open crankcase ventilation system. The gases always flow out of the engine which ultimately draws the unwanted oil contaminants with them, after they've been attracted to the assembly.

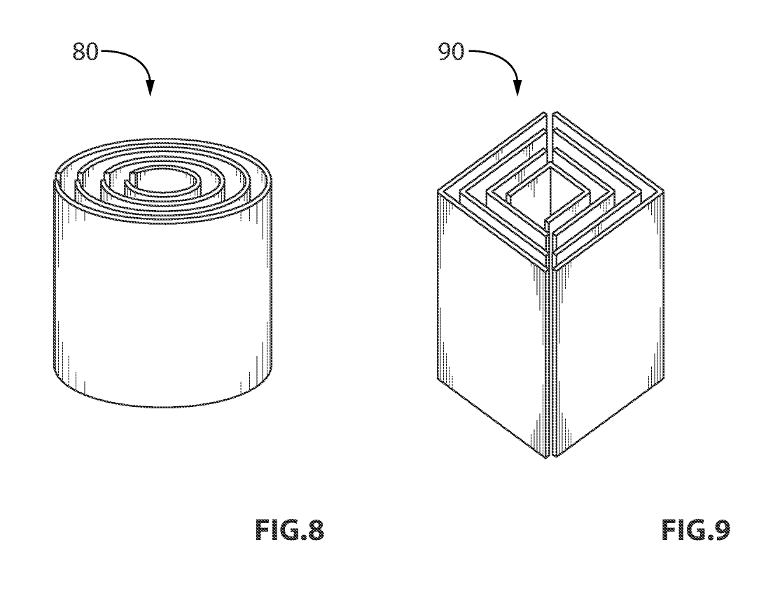

FIG. 8 illustrates the rectangular conditioning deck 80 rolled thereby forming a cylindrical conditioning roll suitable for a cylindrical containment structure,

FIG. 9 illustrates a rectangular conditioning conduit 90 comprising at least one first member comprising four first members joined along their respective lengths to form a first rectangular conduit having a first conduit width and a first conduit, and wherein the at least one second member comprises four second members joined along their respective lengths to form a second rectangular conduit having a second conduit length less equal to said first conduit length and having a second conduit width less than said first conduit width so that the second conduit can be nested within the first conduit and separated by the separation distance thereby forming a rectangular conditioning conduit suitable for a rectangular containment structure.

There are no other components or procedures necessary for this system to function such as electricity, movement, pressure or heat. Field testing indicates an average engine will maintain cleaner oil with relatively minimal viscosity changes for measurably longer intervals. The water removed also reduces acid formation and subsequent corrosion. The oil maintains longer periods of transparency as a result of the carbon particles, of combustion contaminants, being drawn into the assembly and out of the blow-by ventilation system. There are no indications that the assembly won't last indefinitely

What is claimed is:

1. A system for conditioning a fluid thereby improving the performance of said fluid, said system comprising a containment structure for containing an at least one first member comprising a first material having a first Fermi level and an at least one second member comprising a second material comprising a second Fermi level, wherein said first Fermi level is higher than said second Fermi level, and wherein said at least one first member and said at least one second member are adjacent and separated by a separation distance sufficient to permit the fluid to be directed through said containment structure and between the at least one first member and the at least one second member, and wherein the first Fermi level and the second Fermi level interact to create a fluid conditioning electron field through which the fluid passes thereby conditioning the fluid.

2. The system of claim 1 wherein the containment structure is a vessel having an input orifice for connection to a pressurized supply of the fluid and an output orifice for connection to a fluid consumer.

3. The system of claim 1 wherein the at least one first member is a first thin rectangular member having a first width, a first length and a first thickness and wherein the at least one second member is a parallel second thin rectangular member having a second width, a second length and a second thickness so that a first member reactive area having the first Fermi level and a second member reactive area having the second Fermi level are formed.

4. The system of claim 1 wherein said separation distance is created by an at least one spacer disposed between the at least one first member and the at least one second member.

5. The system of claim 1 wherein the at least one first member comprises a plurality of first members and wherein the at least one second member comprises a plurality of second members and wherein said plurality of first members and said plurality of second members are arranged in an alternating adjacent and parallel relationship separated by the separation distance thereby forming a rectangular conditioning deck.

6. The system of claim 5 wherein said rectangular conditioning deck is rolled thereby forming a cylindrical conditioning roll suitable for a cylindrical containment structure.

7. The system of claim 1 wherein the at least one first member comprises tour first members joined along their respective lengths to form a first rectangular conduit having a first conduit width and a first conduit, and wherein the at least one second member comprises four second members joined along their respective lengths to form a second rectangular conduit having a second conduit length less equal to said first conduit length and having a second conduit width less than said first conduit width so that the second conduit can be nested within the first conduit and separated by the separation distance thereby forming a rectangular conditioning conduit suitable for a rectangular containment structure.

8. The system of claim 7 further comprising an additional first rectangular conduit nested within the second rectangular conduit and an additional second rectangular conduit nested within said additional first rectangular conduit.

9. The system of claim 1 wherein the fluid is a non-compressible fluid.

10. The system of claim 1 wherein the fluid is a compressible fluid,

11. The system of claim 5 wherein the fluid is a flow of potable water, the first material is titanium and the second material is silver having a purity greater than 99%.

12. The system of claim 11 wherein the first member and the second member have a first and second thicknesses respectively of between 0.005 inches and 0.010 inches.

13. The system of claim 12 wherein the fluid potable water, the containment structure is a vessel and said rectangular conditioning deck is submerged within said vessel.

14. The system of claim 5 wherein the fluid is a flow of combustion air, said fluid consumer is an internal combustion engine, the first material is titanium and the second material is aluminum.

15. The system of claim 14 wherein the fluid consumer is a wood-tired heating apparatus.

16. The system of claim 1 wherein the fluid is a flow of fuel, the fluid consumer is an internal combustion engine, the first material is titanium and the second material is aluminum.

17. The system of claim 16 wherein the fluid consumer is a cooking apparatus.

18. The system of claim 5 wherein the fluid comprises volatile crankcase emissions from an internal combustion engine crankcase, and wherein the first material is titanium and the second material is aluminum, and wherein the containment structure is disposed within a crankcase ventilation tube and is in fluid communication with said internal combustion engine crankcase so that said volatile crankcase emissions crankcase pass through the containment structure and the conditioning stack the result being that said volatile crankcase emissions are removed.
